(19) United States
(12) Patent Application Publication
(10) Pub. No.: US 2026/0117664 A1
(43) Pub. Date: Apr. 30, 2026

(54) TURBINE RING ASSEMBLY WITH A SEALING PLATE

(71) Applicant: SAFRAN AIRCRAFT ENGINES, PARIS (FR)

(72) Inventors: Clément JARROSSAY, Moissy-Cramayel (FR); Sébastien Serge Francis CONGRATEL, Moissy-Cramayel (FR); Clément Emile André CAZIN, Moissy-Cramayel (FR); Arthur Paul Gabriel NIMHAUSER, Moissy-Cramayel (FR); Moncef M'HASNI, Moissy-Cramayel (FR)

(73) Assignee: SAFRAN AIRCRAFT ENGINES, PARIS (FR)

(21) Appl. No.: 19/469,995

(22) PCT Filed: Mar. 28, 2024
(86) PCT No.: PCT/FR2024/050399

§ 371 Date: Sep. 26, 2025

(30) Foreign Application Priority Data
Mar. 29, 2023 (FR) FR2303042

(51) Int. Cl. F01D 11/00; F01D 25/24

(52) U.S. Cl. CPC F01D 11/005; F01D 25/24; F05D 2240/14; F05D 2240/55; F05D 2260/30; F05D 2300/6033

(57) ABSTRACT

A turbine ring assembly provided with a segmented turbine ring made of CMC and a ring support structure, each segment including a base from which extend, radially outward, an upstream attaching lug and a downstream attaching lug axially spaced apart from one another, the support structure including an upstream radial flange and a downstream radial flange between which are retained the upstream attaching lugs. The assembly further includes, at each join between two adjacent ring segments along the circumferential direction a first cylindrical sealing element extending mainly along the axial direction and disposed between the bases of the two adjacent ring segments, a second sealing element extending radially along the downstream attaching lug from the cylindrical seal forming a sealed connection, and a third sealing element extending radially along the downstream attaching lug from the cylindrical seal forming a sealed connection.

### TECHNICAL FIELD

The invention relates to a turbine ring assembly for a turbomachine in which the assembly comprises a plurality of angular ring segments made of ceramic matrix composite material placed end-to-end to form a turbine ring.

The field of application of the invention is in particular that of aeronautical gas turbine engines. The invention is however applicable to other turbomachines, for example industrial turbines.

### PRIOR ART

In the case of fully metallic turbine ring assemblies, it is necessary to cool all the elements of the assembly and in particular the turbine ring which is subject to the hottest flows. This cooling has a significant impact on the engine performance since the cooling flow used is drawn off the primary flow of the engine. Moreover, the use of metallic material for the turbine ring limits the possibilities for increasing the temperature at the turbine due to the mechanical limits specific to this type of material, which could however make it possible to improve the performance of aeronautical engines.

To attempt to solve these problems, it has been envisioned to make the turbine ring out of ceramic matrix composite (CMC) material to dispense with the employment of a metallic material.

CMC materials have good mechanical properties making them suitable for constituting structural parts and advantageously retain these properties at high temperatures. The employment of CMC materials has advantageously made it possible to reduce the cooling flow required during operation and therefore to increase the performance of turbomachines. Moreover, the implementation of CMC materials advantageously makes it possible to reduce the mass of turbomachines and to reduce the hot expansion effect encountered with metallic parts.

The documents FR 2 540 939, and FR 2 955 898, which disclose turbine ring assemblies, are moreover known.

The ring includes an annular base, the inner face of which defines the inner face of the turbine ring and an outer face from which two lugs radially extend, the ends of which are retained between the two flanges of a metallic ring support structure.

The integration of a CMC ring comprises a radial retainment of the part, partially provided by one or more axial pins. In the known document FR 3 086 327, there are four pins, two upstream and two downstream.

The use of a CMC material for the ring thus makes it possible to significantly reduce the ventilation needed to cool the turbine ring, and therefore to increase the efficiency. They also allow a mass saving since they are lighter than the metallic alloys conventionally used.

However, since a CMC has different mechanical behavior from a metallic material, its integration and also the way of positioning it within the turbine have had to be rethought. Specifically, the CMC may be damaged by press-fitted assemblies (usually used for metallic rings) and its thermal expansion is lower than a metallic material.

There is a need to improve existing turbine ring assemblies and their installation, and particularly turbine ring assemblies employing a CMC material in order to reduce the intensity of the mechanical stresses to which the ring is exposed during the operation of the turbine.

CMC turbine rings are generally divided into several ring segments. This choice of integration is due to the fact that a monobloc assembly would deform under the effect of the high temperatures for this high-pressure turbine part. This would result in a clearance at the movable blade tips (in the air path opposite) that would be locally too high, and thus a severely degraded performance via loss of turbine efficiency.

The consequence of this segmented structure of the turbine ring is the creation of clearances at the inter-segment areas (between 0.1 mm and 1 mm).

To limit leaks in these areas, sealing strips (also known as plates) are generally integrated between the parts. While their effectiveness is notable, to integrate them it is necessary to machine slots at the inter-segment areas of the CMC parts.

However, since CMC is particularly hard, the machining of these slots is very long and complex.

From the document FR3034454 a turbine ring assembly is also known comprising a plurality of CMC ring segments forming a turbine ring and a ring support structure. Each ring segment has a radial section with a K shape, lugs extending from the outer face of the annular base above the end portions of the annular base. The turbine ring assembly comprises a plurality of rigid seals each extending radially between two adjacent ring segments, and elastic retaining devices exerting a force able to retain the seals in contact with the end portions or the lugs of two adjacent ring segments.

The ring assembly described in this document has a set of complexity and bulk limitations that is too significant for its integration, particularly because of the elastic retaining devices used to keep the seals stiff and the thick tab shape of the stiff seal which makes it necessary to make provision for wide slots.

### SUMMARY OF THE INVENTION

This invention therefore has the main aim of making provision for a turbine ring assembly which does not have the aforementioned drawbacks while having a reduced mass and reducing, by the same amount, the intensity of the mechanical stresses to which the CMC ring segments are subjected during the operation of the turbine.

More specifically, the solution of this invention has the aim of limiting wear at the contacts between the CMC ring and the metallic parts.

This aim is achieved owing to a turbine ring assembly comprising a plurality of ring segments made of ceramic matrix composite material forming a turbine ring, defining an axial direction, a radial direction and a circumferential direction, and a ring support structure retained by a turbine casing, each ring segment comprising a base from which extend, radially outward, an upstream attaching lug and a downstream attaching lug axially spaced apart from one another, the ring support structure including an upstream radial flange and a downstream radial flange between which are retained the upstream attaching lug and the downstream attaching lug of each ring segment.

The ring assembly further comprises, at each join between two adjacent ring segments along the circumferential direction, a first sealing element extending mainly along the axial direction and disposed between the bases of the two adjacent ring segments, a second sealing element extending radially along the downstream attaching lug, and a third sealing element extending radially along the downstream attaching lug.

The turbine ring assembly according to the invention is particularly noteworthy in that the first sealing element is a cylindrical seal, the second sealing element extends radially from the cylindrical seal forming a sealed connection, and the third sealing element extends radially from the cylindrical seal forming a sealed connection.

The second and third sealing elements are used both for sealing and for locking the rollers. This in particular makes it possible to dispense with additional parts for retaining these rollers in position in an area of severely limited available volume.

The use of a cylindrical seal makes it possible to considerably reduce, or even eliminate, the sealing slots to be machined in the CMC ring segments and therefore to gain simplicity and save on the manufacturing costs of the parts by comparison with the use of a sealing tab. Specifically, to integrate it, it is no longer necessary to machine a slot of a height between 0.5 mm and 1.5 mm and of considerable depth, but “only” to bevel the faces at the inter-segment areas to make it hold or else to machine a hemispherical groove.

The bearing between the cylindrical seal and the CMC ring segment is then done on a line, and no longer on a surface unlike the provision made in the prior art with tabs inserted into slots.

The invention thus makes it possible to avoid the presence of a chemical interaction between the Nickel of the metal and the free silica of the CMC under the high-temperature operating conditions encountered in the HP Turbine environment. Specifically, tests have shown that the reduction of the contact surface had a first-order effect on the interaction between the materials.

In addition, manufacturing a cylindrical seal rather than a tab offers greater geometrical diversity of the seal to limit the interaction.

The invention is also applicable to other integrations, including with metallic ring segments.

The term “cylindrical shape” should be understood to mean a three-dimensional geometrical shape having a controlled surface, the generatrices of which are parallel, i.e. a surface in space composed of parallel straight lines.

According to a first aspect of the turbine ring assembly, the cylindrical seal may comprise, in a section plane orthogonal to the axial direction, a section with a diameter between 0.5 mm and 5 mm.

According to a second aspect of the turbine ring assembly, each ring segment may comprise a first inter-segment face and a second inter-segment face, each inter-segment face comprising an area of interaction with the cylindrical seal at the height of the base of the ring segment.

According to a third aspect of the turbine ring assembly, the area of interaction may be formed by a bevel of the inter-segment face, or by a semicylindrical inter-segment groove.

Each semicylindrical inter-segment groove has a radius greater than the radius of the cylindrical seal, and between 0.25 mm and 3 mm.

Each bevel of the inter-segment face may form an angle between 10° and 80° with the radial direction. The machining of the bevel of the inter-segment face can be located over the whole of the inter-segment face.

According to a fourth aspect of the turbine ring assembly, the first inter-segment face and the second inter-segment face of each ring segment may each comprise an upstream radial slot extending from the base all the way to a part of the height of the upstream attaching lug, a downstream radial slot extending from the base all the way to a part of the height of the downstream attaching lug, and the assembly being able to further comprise, at each join between two adjacent ring segments along the circumferential direction, an upstream sealing tab which is inserted into the upstream radial slots of the two adjacent ring segments and a downstream sealing tab which is inserted into the downstream radial slots of the two adjacent ring segments, the upstream and downstream sealing tabs being radially disposed outward of the cylindrical seal.

Even if this embodiment involves the machining of two slots, this still means two slots less than the four slots for which provision is made in the prior art, the four slots for which provision is made in the prior art being larger than the two slots of this embodiment. Moreover, the tabs are further from the air path and thus experience temperatures outside the range of chemical interaction with the CMC.

In a variant, the sealing tabs could be replaced by sealing rollers radially disposed in hemispherical grooves which would replace the radial slots.

According to a fifth aspect of the turbine ring assembly, the downstream sealing tab and the upstream sealing tab comprise a notch interacting with the cylindrical seal to radially retain it in position.

According to a sixth aspect of the turbine ring assembly, the cylindrical seal is made of a metallic material chosen from among HA188®, Inco 750-X®, Waspaloy X®, and CMC.

According to a seventh aspect of the turbine ring assembly, to radially retain the ring segment in position with the ring support structure, the ring assembly comprising, for each ring segment, at least a first pin traversing the downstream attaching lug and the downstream radial flange and at least a second pin traversing the upstream attaching lug and the upstream radial flange.

According to an eighth aspect of the turbine ring assembly, the first pin and the second pin are two transverse pins, each transverse pin traversing the upstream attaching lug and the downstream attaching lug of the ring segment and the ring support, to retain the ring segment and the ring support secured to one another.

The invention also has the subject of a turbomachine comprising an assembly as defined previously.

### BRIEF DESCRIPTION OF THE DRAWINGS

FIG. 1 is a schematic section view in a plane comprising the axial direction and the radial direction of a turbine ring assembly according to the invention.

FIG. 2 shows a perspective view of a portion of the turbine ring assembly of FIG. 1.

FIG. 3 shows a zoom of the beveled part of an inter-segment face of the ring segment of FIG. 2.

FIG. 4 shows a first section view of a ring segment according to a second embodiment of the invention.

FIG. 5 illustrates a second section view of a ring segment according to the second embodiment of the invention.

### DESCRIPTION OF THE EMBODIMENTS

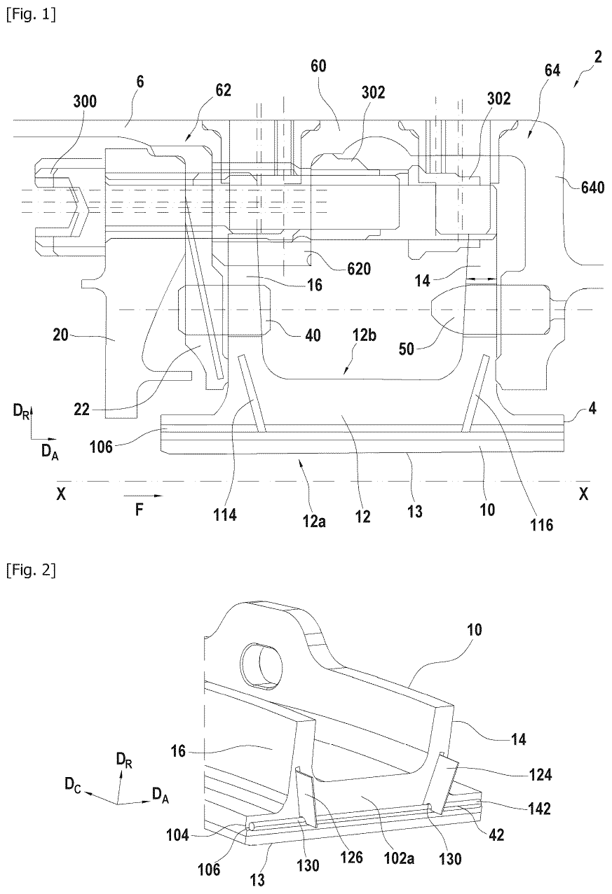

FIG. 1 schematically represents a turbine ring assembly 2 according to a first embodiment of the invention. FIG. 1 is a section view along a plane comprising the radial direction DR and the axial direction DA and orthogonal to the circumferential direction DC.

FIG. 2 shows a perspective view of a portion of the turbine ring assembly of FIG. 1.

The turbine ring assembly 2 shown on FIGS. 1 and 2 particularly comprises a turbine ring 4 made of ceramic matrix composite (CMC) material centered on a longitudinal axis X-X, a metallic ring support structure 6 affixed to a turbine casing not shown for more clarity. The turbine ring 4 surrounds a set of turbine blades, not shown.

The circumferential direction DC is a circular direction centered on the longitudinal axis X-X.

In the remainder of the text, throughout the text, the terms “upstream” and “downstream” are used with reference to the direction of flow of the gas stream F through the blades indicated by an arrow.

Moreover, the turbine ring 4 is formed of a plurality of angular ring segments 10 which are placed end-to-end along the circumferential direction to form a ring. On FIG. 1, the arrow DA indicates the axial direction of the turbine ring while the arrow DR indicates the radial direction of the turbine ring.

Each angular ring segment 10 has a section substantially in the shape of an inverted Pi (or Tt) with a base 12 provided with an inner face 12a which defines an angular portion of the inner face of the turbine ring 4 and which is typically provided with a layer of abradable coating 13 also serving as a thermal and environmental barrier.

Two attaching lugs spaced axially apart, a downstream attaching lug 14 and an upstream attaching lug 16, extend radially from the outer face 12b of the base 12 opposite the inner face 12a. These attaching lugs 14 and 16 extend over the entire width of each ring segment 10 (in the circumferential direction).

The ring support structure 6 comprises a shroud 60 extending around the axis X-X, along with an upstream radial flange 62 and a downstream radial flange 64 extending radially inward from the shroud 60. The downstream radial flange 64 comprises a fastening portion 640 radially protruding from the shroud 60, and the upstream radial flange 62 comprises a fastening portion 620 radially protruding from the shroud 60, as well as a first upstream flange 20 and a second upstream flange 22 affixed to the fastening portion 620 radially protruding from the upstream radial flange 62 using bolts 300 and nuts 302. The first upstream flange 20 is disposed upstream of the second upstream flange 22. The bolts 300 axially traverse the first upstream flange 20, the second upstream flange 22 and the fastening portion 520 of the upstream radial flange 62.

The upstream radial flange 62 and the downstream radial flange 64 thus form two hooking flanges of the ring 4 axially disposed between the downstream attaching lug 14 and the upstream attaching lug 16 of the ring segments 10.

The turbine ring assembly 2 further comprises upstream pins 40 and downstream pins 50. The upstream pins 40 traverse the second upstream flange 22 of the upstream radial flange 62 as well as the upstream lug 16 of a ring segment 10. The downstream pins 50 at least partially traverse the downstream radial flange 64, and more specifically the radially-protruding fastening portion 640, as well as the downstream attaching lug 14.

As illustrated on FIGS. 1 and 2, the ring assembly 2 further comprises at each join between two ring segments 10 adjacent along the circumferential direction DC, a seal 42 of cylindrical shape. The seal 42 is disposed between the bases 12 of the two adjacent ring segments 10, and extends mainly along the axial direction DA, i.e. the base of the cylindrical shape extends in a plane orthogonal to the axial direction DA and the generatrix of the cylindrical shape extend parallel to the axial direction DA.

Preferably, the base of the cylindrical shape forms a disc with a circular outer perimeter. The seal 42 comprises, in a section plane orthogonal to the axial direction DA, a circular section with a diameter between 0.5 mm and 5 mm.

In a variant in which the base of the cylindrical shape is of another shape than disc-shaped, the circular section of the seal 42 is contained in a circle of diameter between 0.5 mm and 5 mm.

Each ring segment 10 comprises a first inter-segment face 102a and a second inter-segment face (102b but not yet visible on FIG. 2), each inter-segment face 102a and 102b comprising an area 104 of interaction with the cylindrical seal 42 at the height of the base 12 of the ring segment 10. At each join between two adjacent ring segments 10, a seal 42 interacts with the first inter-segment face 102a of a first ring segment 10 and the second inter-segment face 102b of a second ring segment 10.

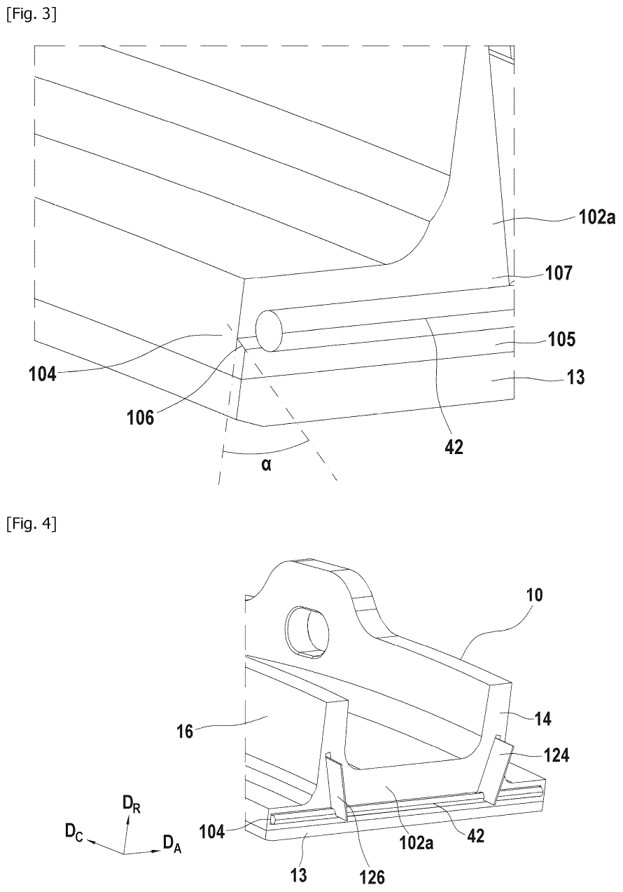

The area 104 of interaction is formed by a bevel 106 of the inter-segment face 102a or 102b. Consequently each inter-segment face, both the first inter-segment face 102a and the second inter-segment face 102b alike, comprises three parts: a radially inward part 105, a radially outward part 107 and an intermediate part 106 forming the bevel and located radially between the radially inward part 105 and the radially outward part 107, as shown on FIGS. 1 and 2 on FIG. 3 which has a zoom of the beveled part of an inter-segment face of the ring segment of FIG. 2.

The radially inward part 105 and the radially outward part 107 of one and the same inter-segment face are parallel to one another, but axially offset. Along the circumferential direction DC, the radially inward part 105 of an inter-segment face is closer to the adjacent ring segment 10 than the radially outward part 107 of the same inter-segment face. In other words, over a ring segment 10, the distance along the circumferential direction DC separating the radially inward part 105 of the first inter-segment face 102a of the ring segment 10 from the radially inward part 105 of the second inter-segment face 102b of the same ring segment 10 is greater than the distance along the circumferential direction DC separating the radially outward part 107 of the first inter-segment face 102a of the ring segment 10 from the radially outward part 107 of the second inter-segment face 102b of the same ring segment 10.

Each bevel 106 of an inter-segment face can form an angle □ between 10° and 80° with respect to the radial direction DR. The machining of the bevel of the inter-segment face extends over the whole of the inter-segment face along the axial direction DA.

As illustrated on FIGS. 1 and 2, the first inter-segment face 102a and the second inter-segment face 102b of each ring segment 10 each comprise an upstream radial slot 116 extending from the base 12 to a part of the height of the upstream attaching lug 16, and a downstream radial slot 114 extending from the base 12 to a part of the height of the downstream attaching lug 14.

The downstream and upstream radial slots 114 and 116 each extend from the bevel 106.

The ring assembly 102 further comprises, at each join between two ring segments 10 adjacent along the circumferential direction DC, an upstream sealing tab 126 which is inserted into the upstream radial slots 116 of the two adjacent ring segments 10 and a downstream sealing tab 124 which is inserted into the downstream radial slots 114 of the two adjacent ring segments, the upstream and downstream sealing tabs 126 and 124 being radially disposed outside the seal 42.

The downstream sealing tab 124 and the upstream sealing tab 126 comprise a notch 130 interacting with the seal 42 to radially retain it in position.

The seals 42 are made of a metallic material chosen from among HA188®, Inco 750-X®, Waspaloy X®, and the CMC.

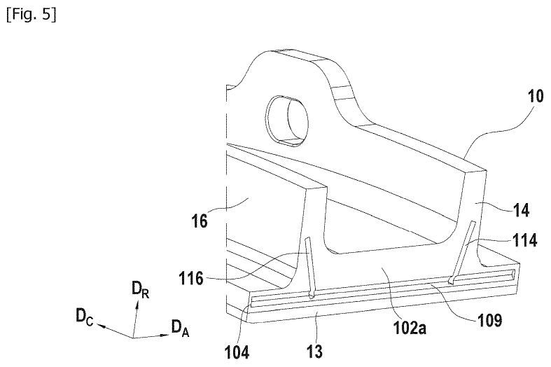

FIGS. 4 and 5 show two section views of a ring segment according to a second embodiment of the invention.

The second embodiment differs from the first embodiment in that the area 104 of interaction of the ring segment 10 with the seal is not a bevel but a semicircular groove 109 into which the seal 42 is partially inserted along the circumferential direction DC.

Each semicylindrical groove 109 has a radius greater than the radius of the seal, and between 0.25 mm and 3 mm.

In an unillustrated variant, the sealing tabs could be replaced by sealing rollers, of a similar design to the seals, radially disposed in hemispherical grooves which would replace the radial slots.

This invention thus makes provision for a turbine ring assembly of reduced mass and reducing by the same amount the intensity of the mechanical stresses to which the CMC ring segments are subjected during the operation of the turbine.

1. A turbine ring assembly comprising a plurality of ring segments made of ceramic matrix composite material forming a turbine ring, defining an axial direction, a radial direction and a circumferential direction, and a ring support structure retained by a turbine casing, each ring segment comprising a base from which extend, radially outward, an upstream attaching lug and a downstream attaching lug axially spaced apart from one another, the ring support structure including an upstream radial flange and a downstream radial flange between which are retained the upstream attaching lug and the downstream attaching lug of each ring segment, the ring assembly further comprising, at each join between two adjacent ring segments along the circumferential direction, a first sealing element extending mainly along the axial direction and disposed between the bases of the two adjacent ring segments, a second sealing element extending radially along the downstream attaching lug, and a third sealing element extending radially along the downstream attaching lug,
wherein the first sealing element a cylindrical seal, the second sealing element extends radially from the cylindrical seal forming a sealed connection, and the third sealing element extends radially from the cylindrical seal forming a sealed connection.

2. The turbine ring assembly as claimed in claim 1, wherein the seal comprises, in a section plane orthogonal to the axial direction, a section with a diameter between 0.5 mm and 5 mm.

3. The turbine ring assembly as claimed in claim 1, wherein each ring segment comprises a first inter-segment face and a second inter-segment face, each inter-segment face comprising an area of interaction with the seal at the height of the base of the ring segment.

4. The turbine ring assembly as claimed in claim 3, wherein the area of interaction is formed by a bevel of the inter-segment face.

5. The turbine ring assembly as claimed in claim 3, wherein the area of interaction is formed by a hemispherical inter-segment groove.

6. The turbine ring assembly as claimed in claim 3, wherein the first inter-segment face and the second inter-segment face of each ring segment comprise an upstream radial slot extending from the base all the way to a part of the height of the upstream attaching lug, a downstream radial slot extending from the base all the way to a part of the height of the downstream attaching lug, and the assembly further comprising, at each join between two adjacent ring segments along the circumferential direction, an upstream sealing tab which is inserted into the upstream radial slots of the two adjacent ring segments and a downstream sealing tab which is inserted into the downstream radial slots of the two adjacent ring segments, the upstream and downstream sealing tabs being radially disposed outward of the cylindrical seal.

7. The turbine ring assembly as claimed in claim 6, wherein the downstream sealing tab and the upstream sealing tab comprise a notch interacting with the seal to radially retain it in position.

8. The turbine ring assembly as claimed in claim 1, wherein the seal is made of a metallic material chosen from among A600®, Hastelloy X®, HA188®, and HS25®.

9. The turbine ring assembly as claimed in claim 1, wherein to radially retain the ring segment in position with the ring support structure, the ring assembly comprising, for each ring segment, at least a first pin traversing the downstream attaching lug and the downstream radial flange and at least a second pin traversing the upstream attaching lug and the upstream radial flange.

10. The turbine ring assembly as claimed in claim 9, wherein the first pin and the second pin are two transverse pins, each transverse pin traversing the upstream attaching lug and the downstream attaching lug of the ring segment and the ring support to retain the ring segment and the ring support secured to one another.

11. A turbomachine comprising an assembly as claimed in claim 1.
